(19) United States
(12) Patent Application Publication
(10) Pub. No.: US 2012/0290347 A1
(43) Pub. Date: Nov. 15, 2012

(54) PROGRESS MONITORING METHOD

(75) Inventors: ASHRAF ELAZOUNI, DHAHRAN (SA); OSAMA SALEM, BURAYDAH (SA)

(73) Assignee: KING FAHD UNIVERSITY OF PETROLEUM AND MINERALS, Dhahran (SA)

(21) Appl. No.: 13/558,195

(22) Filed: Jul. 25, 2012

Related U.S. Application Data
(63) Continuation-in-part of application No. 12/854,132, filed on Aug. 10, 2010.

(51) Int. Cl. G06Q 10/06

(52) U.S. Cl. 705/7.12

(57) ABSTRACT

The progress monitoring method is based on a critical path method (CPM) and conducts comparisons against multiple possible outcomes utilizing neural networks that classify planned progress at specified cut-off dates during a planning stage. The classifications are used to monitor and evaluate actual progress during the construction stage. The pattern recognition techniques generalize a virtual benchmark to represent planned progress based on multiple possible outcomes generated at each cut-off date. The generalization feature overcomes the problem of variation in the quality of data collected. Patterns are constructed to encode planned and actual progress at different cut-off dates. Patterns are readily manipulated within computer programs and substitute for photographs, which are not comprehensive in representing the work status of interior and hidden parts of the under-construction facilities.

### CROSS-REFERENCE TO RELATED APPLICATION

This application is a continuation-in-part of U.S. patent application Ser. No. 12/854,132, filed Aug. 10, 2010.

### BACKGROUND OF THE INVENTION

1. Field of the Invention

The present invention relates to computerized monitoring methods and systems, and particularly to a progress monitoring method that uses a neural network in the course of monitoring the progress of construction projects.

2. Description of the Related Art

Traditional construction project monitoring practices involve collecting actual progress, and comparing against a benchmark, which represents the relevant, planned progress. A well-known problem in monitoring is that the quality of the collected data is often subjected to great variation due to the variation in reporting skills as well as variation in the willingness to record data accurately. The variation in data quality often results in inaccurate progress estimation.

Thus, a progress monitoring method solving the aforementioned problems is desired.

### SUMMARY OF THE INVENTION

The progress monitoring method is based on a critical path method (CPM) and conducts comparisons against multiple possible outcomes utilizing neural networks, which classify planned progress at specified cut-off dates during a planning stage. The classifications are used to monitor and evaluate actual progress during the construction stage. The pattern recognition techniques generalize a virtual benchmark to represent planned progress based on multiple possible outcomes generated at each cut-off date. The generalization feature overcomes the problem of variation in the quality of data collected. Patterns are constructed to encode planned and actual progress at different cut-off dates. Patterns are readily manipulated within computer programs and substitute for photographs, which are not comprehensive in representing the work status of interior and hidden parts of the under-construction facilities.

In use, a Critical Path Method (CPM) schedule of a project is first built. Then, during a planning stage of the project, pattern sets of cut-off dates of the project to the CPM schedule are mapped. During the planning stage, project cut-off date weeks corresponding to the pattern sets of the project cut-off dates are identified, and the pattern sets and corresponding project cut-off date weeks are applied as inputs to a neural network pattern recognition model, which is preferably a neural network pattern recognition model of a Hopfield network.

At least one of the generated patterns is then used to train the neural network pattern recognition model to classify work planned at specified cut-off dates. The remaining patterns are used to test the neural network pattern recognition model after it has been trained. During the construction stage of the project, at the same cut-off dates, the project is monitored.

At any desired cut-off date, a corresponding descriptive pattern is prepared, such that the corresponding descriptive pattern describes actual work accomplishments during a time period defined by the desired cut-off date. The descriptive pattern is input into the neural network pattern recognition model. The model declares a week of convergence for the descriptive pattern input. The week of convergence declared by the neural network pattern recognition model is compared to the cut-off date week of the associated cut-off date pattern set, thereby determining whether actual progress of the project is on schedule, ahead of schedule, or behind schedule. A progress monitoring report is then prepared based upon the determined actual progress, and the progress monitoring report is displayed to a user.

These and other features of the present invention will become readily apparent upon further review of the following specification and drawings.

### BRIEF DESCRIPTION OF THE DRAWINGS

FIG. 1 is a block diagram of a CPM network of the 25-activity project.

FIG. 2 is a tabular diagram representing the pattern of the 25-Activity project.

FIG. 3 is a diagram representing the first ten patterns for the 25-activity project.

FIG. 4 is a diagram representing the second ten patterns for the 25-activity project.

FIG. 5A is a tabular diagram representing the Input pattern at the end of week 3.

FIG. 5B is a tabular diagram representing the output pattern at the end of week 3.

FIG. 6 is a tabular diagram representing the 3-day extension scheme of the 25-activity project.

FIGS. 7A and 7B are tabular diagrams representing the reference pattern.

FIGS. 8A and 8B are tabular diagrams representing the delayed-start pattern.

FIGS. 9A and 9B are tabular diagrams representing the extended duration of activities A, B, C, and D pattern.

FIG. 10 is a block diagram illustrating system components for implementing the progress monitoring method according to the present invention.

Similar reference characters denote corresponding features consistently throughout the attached drawings.

### DETAILED DESCRIPTION OF THE PREFERRED EMBODIMENTS

The progress monitoring method is based on a critical path method (CPM), which conducts comparisons against multiple possible outcomes utilizing neural networks to classify planned progress at specified cut-off dates during a planning stage. The classifications are used to monitor and evaluate actual progress during the construction stage. The pattern recognition techniques generalize a virtual benchmark to represent planned progress based on multiple possible outcomes generated at each cut-off date. The generalization feature overcomes the problem of variation in the quality of data collected. Patterns are constructed to encode planned and actual progress at different cut-off dates. Patterns are readily manipulated within computer programs and substitute for photographs, which are not comprehensive in representing the work status of interior and hidden parts of the under-construction facilities.

Neural Network Pattern Recognition (NN-PR) classifies the planned progress at the specified cut-off dates during the planning stage and uses this classification to monitor and evaluate the actual progress during the construction stage. This involves designing patterns that map CPM schedules to describe the planned progress during the project planning stage and actual progress during the construction stage. Patterns lend themselves well to manipulation by computer programs and substitute for photographs, which cannot be comprehensive in representing the work status of the interior and hidden parts of the facility under construction.

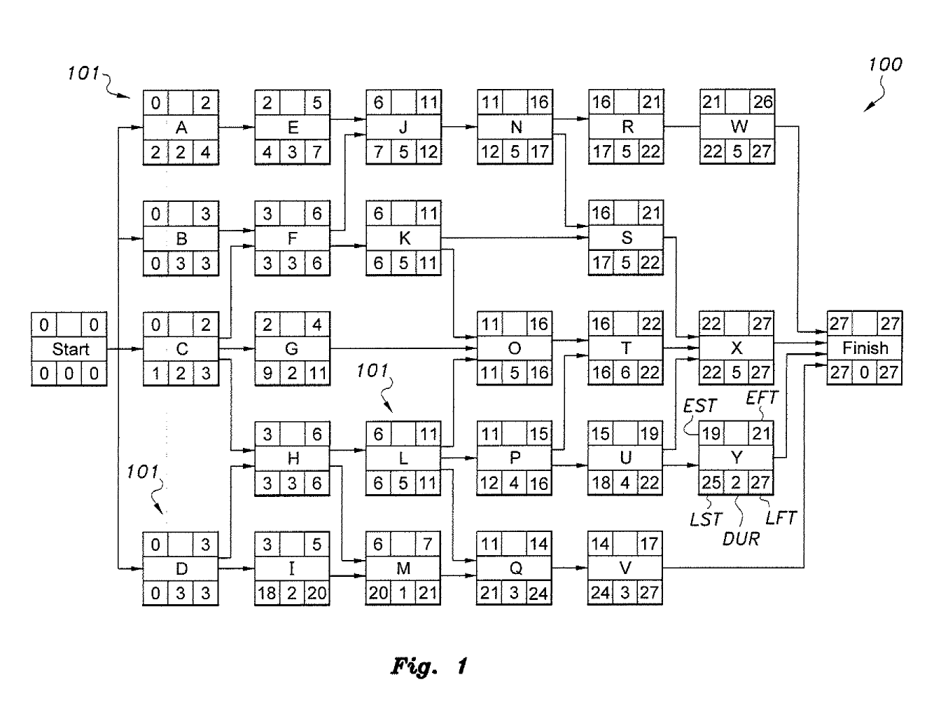

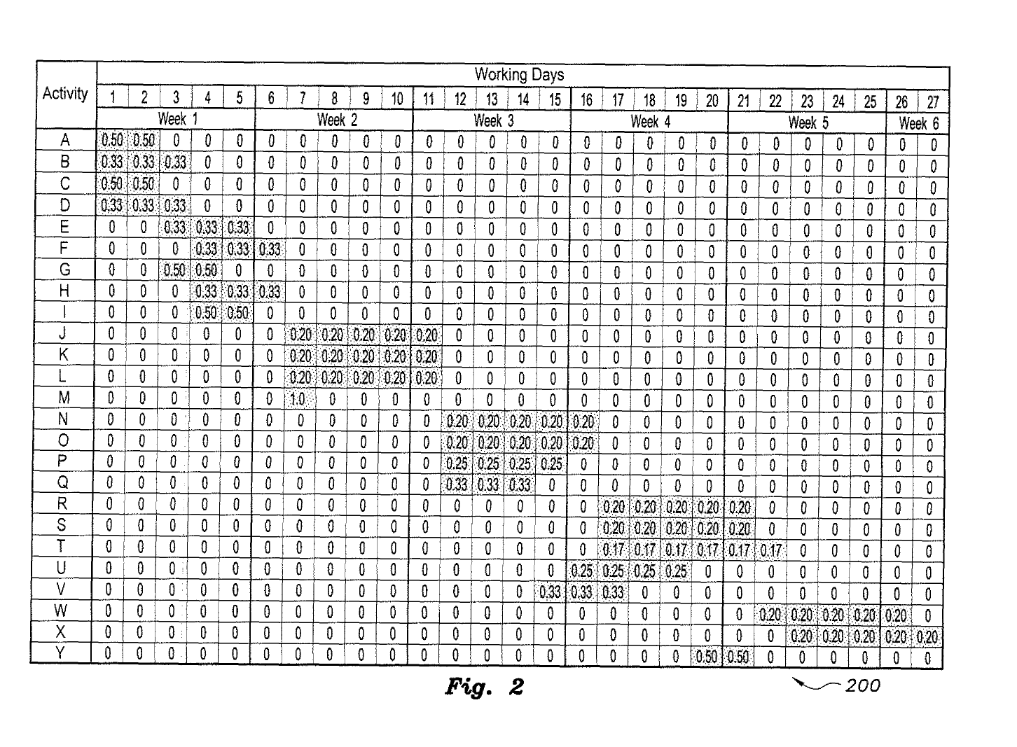

FIGS. 1 and 2 show the CPM network and the corresponding early-start pattern, respectively, of an example project of twenty-five activities with a duration of twenty-seven days. The CPM network 100 and the corresponding pattern exemplify a project having twenty-five activities. The tasks are labeled A through Y. Each CPM network box 101 is labeled with an earliest possible start for activity EST, an earliest possible finish for activity EFT, a latest possible start for activity LST, an activity duration DUR, and a latest possible finish for activity LFT. During the planning phase of the project, cut-off dates separating a monitoring period of one week are specified. As shown in FIG. 2, the pattern structure is a matrix 200 having twenty-five rows and twenty-seven columns corresponding to the number of activities and working days, respectively. Activities are encoded in the patterns using horizontal non-intermittent bars, which start at the early-start times and span as many cells as the activities' durations in days. The planned progress can be represented by filling in the activities' cells with fractions that indicate the proportion of the planned progress involved during the individual days. For example, activity A, which starts at first day of the project and has a duration of two days, can be represented using a bar of two cells, the daily planned progress being equal to half of the total involved work. The remaining cells of the matrix are filled in with entries of “zero”. Thus, matrix 200 constitutes a pattern that perfectly maps the bar chart of the project and can be manipulated within computer programs.

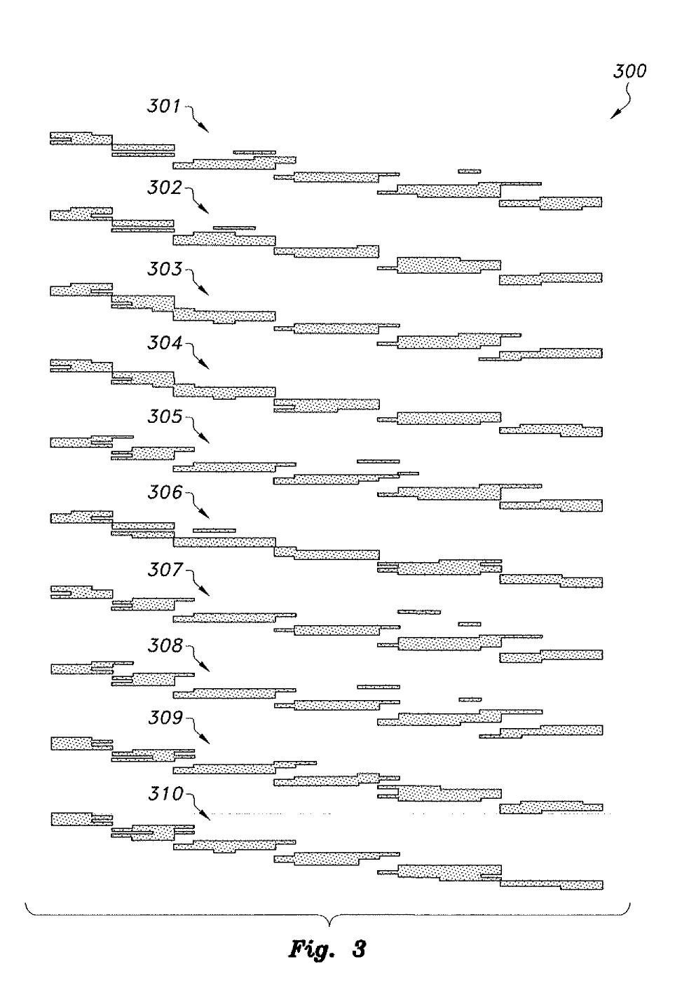

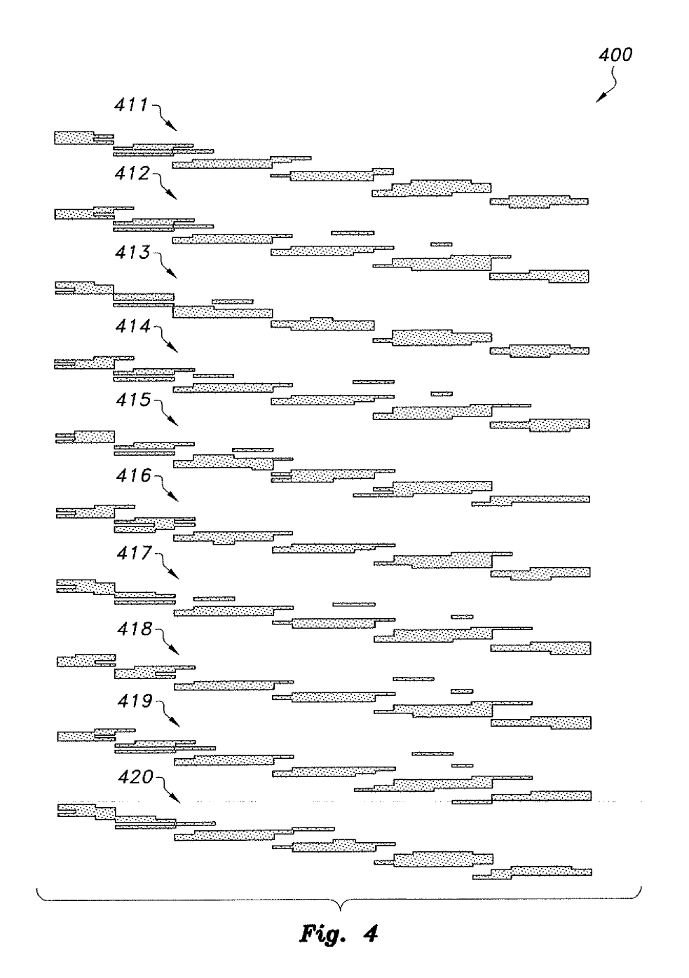

A computer code was written to generate alternative schedules by assigning random values to the activities' start times within the ranges intercepted between the activities' early-start EST and late-start LST times, while maintaining the dependencies amongst activities. As shown in FIGS. 3 and 4, twenty schedules, with the equivalent first ten schedules 300 comprising patterns 301 through 310, and second ten schedules 400 comprising patterns 411 through 420, are generated for the 25-activity project 100 diagrammed in FIG. 1. The generated schedules are of the same duration, and consequently will lead to patterns having the same number of columns. The variation between the generated patterns is entirely attributed to the variation of the start times of the activities. In this context, a large number of random patterns can easily be generated at no cost to control the recognition performance of the employed pattern recognition techniques.

Moreover, each pattern in the set of twenty patterns 301-310 and 411-420 is used to generate patterns at the cut-off dates. Five more patterns for the five cut-off dates separating weeks are created by curtailing the complete pattern in FIG. 2 at the respective cut-off dates. The same number of twenty-seven columns in the matrix of the complete pattern is maintained in the created patterns by entering zeros in the cells of the columns to the right of the cut-off dates. Accordingly, six patterns are associated with each of the twenty random patterns in FIGS. 3 and 4 to provide a total of one hundred twenty patterns.

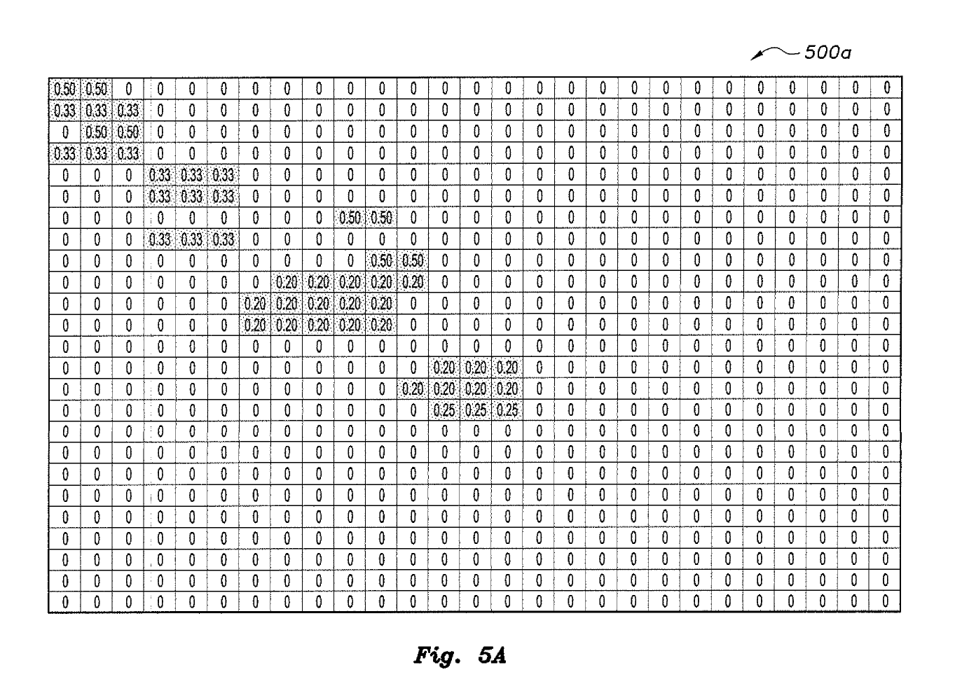

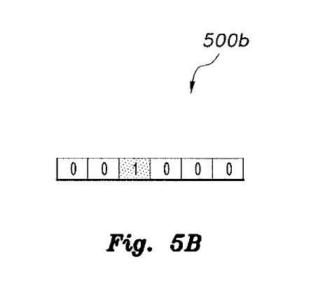

Thus, for each cut-off date including the project completion there is a set of twenty different patterns to encode different possible planned progress. On the other hand, a matrix of one row with six cells is constructed to encode the week corresponding to a given pattern. An entry of “one” is entered in the cell corresponding to the week of the pattern and zeros are entered in the remaining cells. For the first pattern in FIG. 3, the pattern of the third week 500a and its associated week pattern 500b are shown in FIGS. 5A and 5B. The set of one hundred twenty patterns, along with the associated week patterns, constitutes the input/output patterns that could be used for training and testing the neural network-pattern recognition (NN-PR) models.

Preferably, a Hopfield network is utilized for the neural network-pattern recognition. A Hopfield network is a form of recurrent artificial neural network. Hopfield networks serve as content-addressable memory systems with binary threshold units. They are guaranteed to converge to a local minimum, but convergence to one of the stored patterns is not guaranteed. Training a Hopfield network involves lowering the energy of states that the net should “remember”. This allows the net to serve as a content addressable memory system; i.e., the network will converge to a “remembered” state if it is given only part of the state. The net can be used to recover from a distorted input the trained state that is most similar to that input. This is called “associative memory” because it recovers memories on the basis of similarity. For example, if a Hopfield network is trained with five units so that the state (1,0,1,0,1) is an energy minimum, and the network is given the state (1,0,0,0,1), it will converge to (1,0,1,0,1). Thus, the network is properly trained when the energy of states that the network should remember are local minima.

During the construction stage of the project, project monitoring is pursued regularly at the same cut-off dates specified during the planning stage. At a given cut-off date, a pattern is constructed to encode the actual progress. This involves specifying the actual start times of the completed and partially completed activities, measuring the actual daily progress up to the current cut-off date, and encoding the actual daily progress into the pattern, as described earlier. The resulting pattern, which represents the current status of the project, is introduced as an input pattern to the trained NN-PR models. The trained models will declare the week that the input pattern tends to converge to its patterns. Comparing the date of the declared week to the cut-off date of the input pattern will indicate whether the actual progress is ahead or behind the planned progress. Thus, the pattern recognition technique automatically implements the task of project monitoring and evaluation.

The implementation of pattern recognition using the NN pattern recognition models is described in detail below. The employed PR techniques include the feed-forward, back-propagation NN-PR model (Abdel-Wahhab and Sid-Ahmed 1997).

As explained before, the set of data for training and testing the model constitutes a total of one hundred twenty input/output patterns representing the twenty randomly generated patterns. Thus, the input pattern to the NN-PR model is a vector of six hundred seventy-five elements representing the entries of a 27-column and 25-row matrix. The output pattern is a vector of six elements representing the project completion and the five cut-off dates. The model was trained on two patterns out of the twenty random patterns, comprising twelve input/output patterns. Ten runs were performed using two different training patterns that were selected randomly of the twenty patterns in each run. The individual patterns of the twelve pattern groups were used for updating the network weights and biases, and were entered randomly to the neural network. The NN-PR was configured by changing the number of hidden layers and the number of neurons in each hidden layer. It was observed that the best performance was obtained at a configuration of one hidden layer containing forty-three neurons. Training continues until a maximum number of fifty epochs occurs, or the error value, determined by the summation of the squares of the difference between the actual and desired output of the neurons, becomes less than 1×10⁻⁸. Then, the training session is stopped, and the weights and biases at the minimum value of error are returned.

The trained NN-PR model was tested using the remaining eighteen patterns representing one hundred eight input/output patterns. Thus, testing was performed using patterns that were not introduced to the NN-PR model during the training session. When a particular test pattern is entered to the trained NN-PR model, the recognized week is the week exhibiting the highest output among the six weeks. The recognition errors are presented in Table 1 for the ten runs.

TABLE I
Neural network re: Two training and eighteen testing patterns

| Pat- | Runs | | | | | | | | | |
|---|---|---|---|---|---|---|---|---|---|---|
| terns | 1 | 2 | 3 | 4 | 5 | 6 | 7 | 8 | 9 | 10 |
| 301 | — | 4(5) | — | — | — | — | 3(4) | — | — | 5(6) |
| 302 | — | — | — | — | — | R | — | — | R | — |
| 303 | — | 4(5) | — | — | — | — | R | — | — | — |
| 304 | 3(4) | 4(5) | — | — | — | — | — | — | — | — |
| | | 5(6) | | | | | | | | |
| 305 | — | 4(5) | — | — | 5(6) | — | — | — | — | 5(6) |
| 306 | — | — | — | — | — | — | — | — | — | — |
| 307 | — | 4(5) | — | — | 5(6) | — | — | — | — | — |
| 308 | — | 4(5) | — | — | R | — | — | — | — | — |
| 309 | R | — | — | 4(5) | — | — | — | — | — | — |
| | | | | 5(6) | | | | | | |
| 310 | 3(4) | — | R | R | R | — | — | R | — | — |
| 411 | — | — | — | — | 5(6) | — | — | — | — | — |
| 412 | R | — | — | — | 5(6) | — | 3(4) | — | — | — |
| 413 | — | — | — | — | 5(6) | — | — | — | — | 5(6) |
| 414 | — | 4(5) | — | — | 5(6) | — | — | — | — | — |
| 415 | 3(4) | R | — | — | 5(6) | — | R | — | — | — |
| 416 | — | — | — | — | 5(6) | — | — | — | — | — |
| 417 | — | — | — | R | 5(6) | R | 3(4) | R | — | R |
| 418 | — | — | — | — | 5(6) | 4(3) | — | — | — | — |
| 419 | — | 4(5) | 5(6) | — | 5(6) | 4(3) | — | — | — | R |
| 420 | — | R | R | — | — | — | — | — | R | — |
| Total | 3 | 9 | 1 | 2 | 11 | 2 | 3 | 0 | 0 | 3 |
| errors | | | | | | | | | | |
| Error | 2.78 | 8.33 | 0.93 | 1.85 | 10.19 | 1.85 | 2.78 | 0 | 0 | 2.78 |
| per- | | | | | | | | | | |
| cent- | | | | | | | | | | |
| age | | | | | | | | | | |

#(#): Week pattern/Recognized as week pattern
R: Training pattern

The recognition errors didn't exceed the immediate upper and lower week in all runs, and there was a consistency regarding the type of errors over the patterns of the same run. It is observed in Table 1 that the number and type of errors depends on the selected training patterns.

This is evident in runs 8 and 9, wherein all the patterns were recognized correctly, while the other runs exhibit some recognition errors. For example, the first run, which used patterns 309 and 412 for training, exhibited three erroneous recognitions associated with patterns 304, 310, and 415. The three errors are identical, wherein the third-week patterns were recognized as the fourth-week patterns. Three errors out of one hundred eight total recognition tests constitutes a recognition error percentage of 2.78%. The average recognition error for the ten runs was 3.15%. Moreover, the results in Table 1 indicate that out of the one hundred eighty testing patterns, the right recognitions of the six cut-off dates were attained in one hundred forty-eight patterns, which represents 82.2%. The number of the patterns with one erroneous recognition and two erroneous recognitions, respectively, were thirty and two, which constitute 16.7%, and 1.1%, respectively. The low error value obtained with this low number of training patterns proves the effectiveness of the NN-PR model as a progress monitoring and evaluation technique for construction projects.

Since it is practically possible to generate any desired number of random patterns at absolutely no cost for a typical construction project, the recognition performance of the NN-PR model can be calibrated by determining the number of training patterns resulting in error-free recognition. Out of the twenty random patterns, it was found that the minimum number of training patterns that result in error-free recognition when testing using the remaining patterns was nine patterns. Table 2 presents the randomly selected nine training patterns and the remaining eleven testing patterns for ten different runs. In other words, nine training patterns with activities' start times selected within the range between the early and late start times were sufficient for the NN-PR model to correctly recognize all the testing patterns.

TABLE 2
Neural Network training: Nine training and eleven testing patterns

| | Runs | | | | | | | | | |
|---|---|---|---|---|---|---|---|---|---|---|
| Patterns | 1 | 2 | 3 | 4 | 5 | 6 | 7 | 8 | 9 | 10 |
| 1 | T | R | R | R | R | R | R | T | R | R |
| 2 | R | T | R | T | T | T | T | T | T | R |
| 3 | T | T | T | T | R | R | T | R | T | T |
| 4 | T | R | R | T | R | R | T | T | T | R |
| 5 | R | T | T | R | T | T | R | R | R | T |
| 6 | T | T | T | R | T | R | T | R | R | T |
| 7 | T | T | R | R | T | T | T | T | T | T |
| 8 | T | R | T | T | T | T | T | T | T | T |
| 9 | T | R | R | R | T | T | T | R | R | T |
| 10 | T | T | R | T | T | R | T | T | T | R |
| 11 | R | T | T | R | R | T | R | R | T | T |
| 12 | R | R | T | T | R | T | T | T | R | T |
| 13 | T | T | T | R | T | T | R | T | R | T |
| 14 | R | T | R | T | R | T | T | R | T | R |
| 15 | T | R | T | T | R | T | R | T | T | T |
| 16 | R | R | T | T | R | R | R | T | R | R |
| 17 | R | R | T | T | T | R | R | R | T | T |
| 18 | R | R | R | R | T | T | R | R | R | R |
| 19 | R | T | R | T | T | R | T | T | R | R |
| 20 | T | T | T | R | R | R | R | R | T | R |

T: Testing pattern
R: Training pattern

Typically, construction projects regularly monitor to check whether the activities are started and finished within the range between the early-start time EST and the late-finish time LFT to ensure that the project is finished on the scheduled completion date. Occasionally, the completion date stipulated in the contract allows schedulers to creep projects' completion dates beyond the originally scheduled up to certain limits. This time contingency, regardless of whether it is disclosed to the site staff or kept as a confidential reserve, adds additional floats to the individual activities. The incorporation of the additional activities' floats entails some adjustment of the original schedules before the preparation of the random patterns. This adjusted schedule is referred to as an extension.

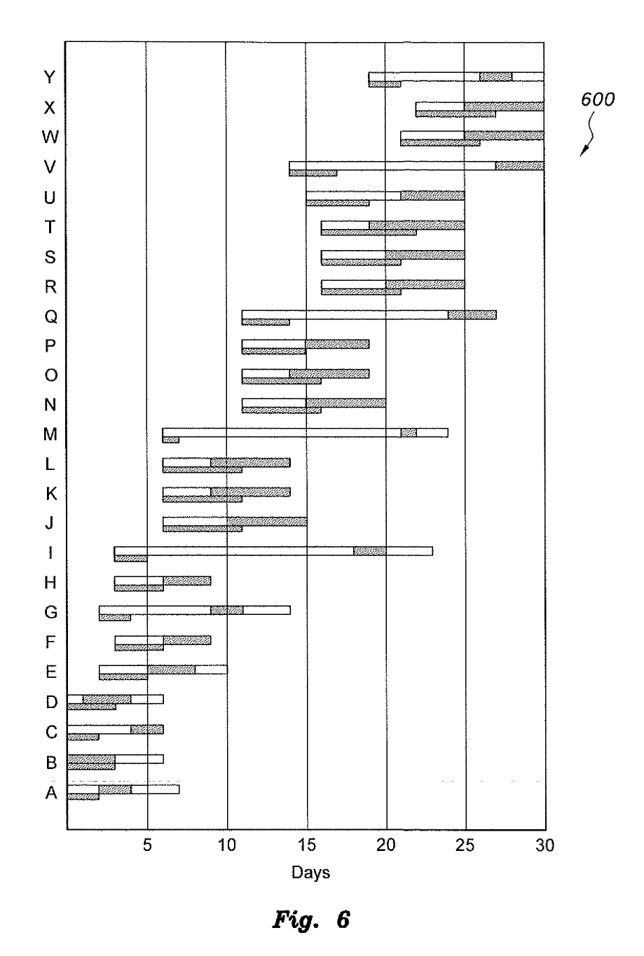

The extension scheme is a special framework for extending the project duration while keeping the networking basics intact. FIG. 6 shows the early-start bar chart 600 of the 25-activity project, charted using thin bars, and the extension scheme, indicated by thick bars. This extension scheme adjusts the original schedule by adding a 3-day extension increment to the original project duration of twenty-seven days. The total float of the terminating activity of the network is supplemented with the 3-day extension. Since the total float of a given activity is shared by all activities on its path, and given that the terminating activity is a common activity in all paths traversing the network, the extension increment is shared by all activities of the network. Thus, the total float values of all the network activities are supplemented with three days. In other words, the late-start and late-finish times of the network activities are delayed by three days. The thick bars in chart 600 indicate the ranges from the early-start times to the delayed late-finish times. The aforementioned computer program was used to generate twenty schedules for the 3-day extension scheme by assigning random values to the activities' start times within the ranges intercepted between the activities' early-start and delayed late-start times, while maintaining the dependencies amongst activities. The hatched thick bars shown in chart 600 represent the first schedule of the twenty random schedules.

As was explained in detail before for data preparation, the set of data for training and testing the model constitutes a total of one hundred twenty input/output patterns representing the twenty randomly generated patterns. The input pattern to the NN-PR model is a vector of seven hundred fifty elements, representing the entries of a 30-column and 25-row matrix. The output pattern is a vector of six elements representing the project completion and the five cut-off dates. The model was trained on three patterns out of the twenty random patterns, comprising eighteen input/output patterns. It was observed that the best performance was obtained at the same configuration of one hidden layer containing forty-three neurons. Ten runs were performed using three different training patterns being selected randomly of the twenty patterns for each run. The individual patterns of the eighteen pattern groups were used for updating the network weights and biases and were entered randomly to the NN model. The training session is continued until the same stopping criteria mentioned above are met, and then the weights and biases at the minimum value of error are returned.

Upon the completion of the training sessions, the trained NN model was tested using the remaining seventeen patterns, representing one hundred two input/output patterns that were not introduced to the NN during the training session. The recognition errors are presented in Table 3 for the ten runs.

TABLE 3
Neural network recognition errors: three training and seventeen
testing patterns:

| | Runs | | | | | | | | | |
|---|---|---|---|---|---|---|---|---|---|---|
| Patterns | 1 | 2 | 3 | 4 | 5 | 6 | 7 | 8 | 9 | 10 |
| 1 | — | — | — | — | — | — | — | — | — | 5(6) |
| 2 | — | — | R | — | — | — | R | — | — | 5(6) |
| 3 | — | — | R | — | — | — | — | — | — | 5(6) |
| 4 | — | 4(5) | — | R | — | — | — | — | — | — |
| 5 | — | 4(5) | — | — | R | — | — | — | — | 5(6) |
| 6 | — | 4(5) | 4(5) | — | — | — | — | — | — | 5(6) |
| 7 | R | 4(5) | 4(5) | — | — | — | — | R | — | R |
| 8 | — | — | R | 3(4) | — | — | — | — | R | — |
| 9 | — | 4(5) | 4(5) | — | — | 5(6) | R | — | R | R |
| 10 | — | R | 4(5) | R | — | 5(6) | — | — | — | 5(6) |
| 11 | — | 4(5) | 4(5) | R | — | R | R | R | — | 5(6) |
| 12 | — | — | — | — | — | — | — | — | — | 5(6) |
| 13 | — | R | — | — | — | R | — | — | R | 5(6) |
| 14 | — | 4(5) | — | — | — | — | 4(5) | R | — | — |
| | | | | | | | 5(6) | | | |
| 15 | 4(5) | — | — | — | — | — | — | — | — | — |
| | 5(6) | | | | | | | | | |
| 16 | R | 4(5) | — | 3(4) | — | — | — | — | — | — |
| | | 5(6) | | | | | | | | |
| 17 | R | — | 4(5) | — | — | — | — | — | — | R |
| | | | 5(6) | | | | | | | |
| 18 | — | — | 4(5) | 3(4) | R | 5(6) | — | — | — | 5(6) |
| 19 | — | — | — | — | — | R | — | — | — | 5(6) |
| 20 | — | R | 4(5) | — | R | — | — | — | — | — |
| Total | 2 | 9 | 9 | 3 | 0 | 3 | 2 | 0 | 0 | 11 |
| errors | | | | | | | | | | |
| Error | 1.96 | 8.82 | 8.82 | 2.94 | 0 | 2.94 | 1.96 | 0 | 0 | 10.78 |
| percent- | | | | | | | | | | |
| age | | | | | | | | | | |

#(#): Week pattern/Recognized as week pattern
R: Training pattern

The recognition errors didn't exceed the immediate upper weeks in all runs. The average recognition error for the ten runs was 3.82%. The results in Table 3 indicate that out of the one hundred seventy testing patterns, correct recognition of the six cut-off dates occurred in one hundred thirty-five patterns, which represents 79.4%. The number of the patterns with one erroneous recognition and two erroneous recognitions were thirty-one and four, which represent 18.2% and 2.4%, respectively. The NN-PR model was calibrated by determining the number of training patterns that will result in error-free recognition. The model calibration indicated that nine is the minimum number of training patterns resulting in error-free recognition when the remaining patterns were used during testing.

Table 4 presents the randomly selected nine training patterns and the remaining eleven testing patterns for the ten different runs.

TABLE 4
Neural network testing: Nine training and eleven testing patterns

| | Runs | | | | | | | | | |
|---|---|---|---|---|---|---|---|---|---|---|
| Patterns | 1 | 2 | 3 | 4 | 5 | 6 | 7 | 8 | 9 | 10 |
| 1 | T | R | R | R | R | T | R | R | T | R |
| 2 | R | R | R | R | T | T | R | R | R | R |
| 3 | T | R | R | R | T | R | R | T | T | T |
| 4 | R | T | R | R | T | T | T | T | T | T |
| 5 | T | R | T | R | T | T | R | R | R | T |
| 6 | T | R | T | T | T | T | T | T | R | T |
| 7 | R | T | R | T | T | R | R | R | T | R |
| 8 | R | R | T | R | R | R | R | R | R | R |
| 9 | R | T | R | T | T | T | T | T | T | T |
| 10 | T | R | T | T | T | T | T | T | R | R |
| 11 | R | T | T | T | R | R | T | T | R | T |
| 12 | T | R | R | T | T | R | R | R | T | T |
| 13 | R | T | T | T | R | T | T | R | T | R |
| 14 | T | T | R | T | T | R | T | T | R | T |
| 15 | T | T | T | R | R | R | T | R | T | R |
| 16 | T | T | T | T | R | R | T | T | T | T |
| 17 | R | R | R | R | R | R | T | T | T | R |
| 18 | T | T | T | R | R | T | R | T | R | T |
| 19 | R | T | T | T | R | T | T | R | R | R |
| 20 | T | T | T | T | T | T | R | T | T | T |

T: Testing pattern
R: Training pattern

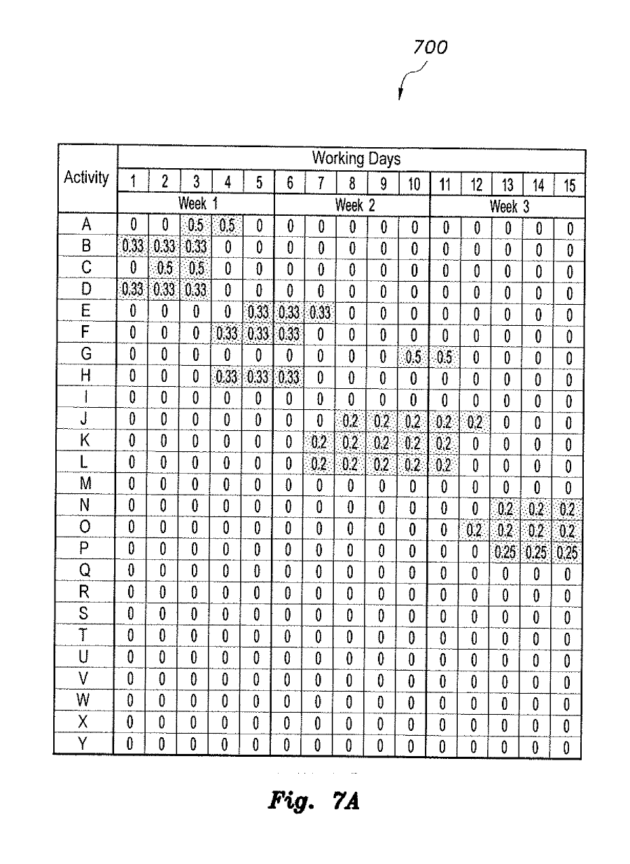

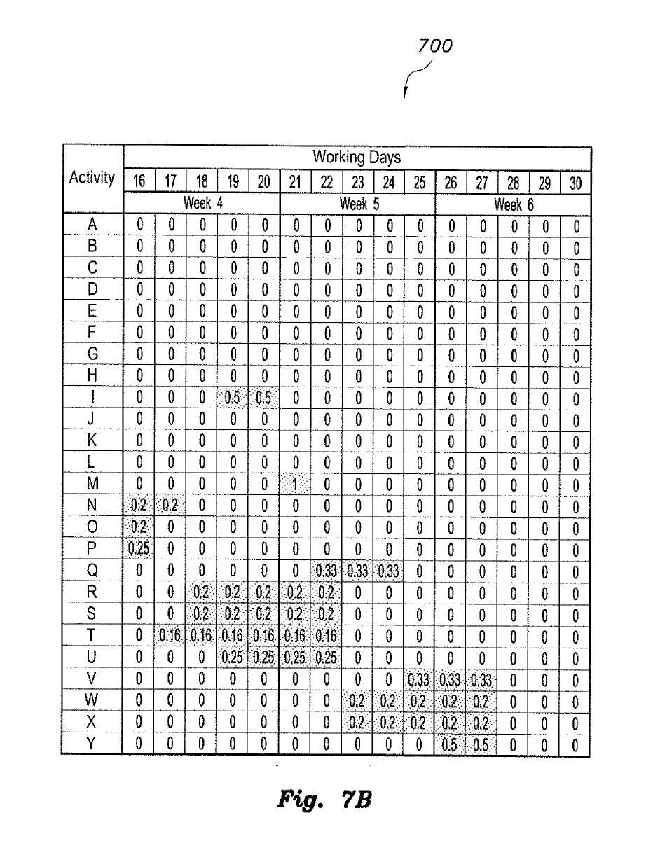

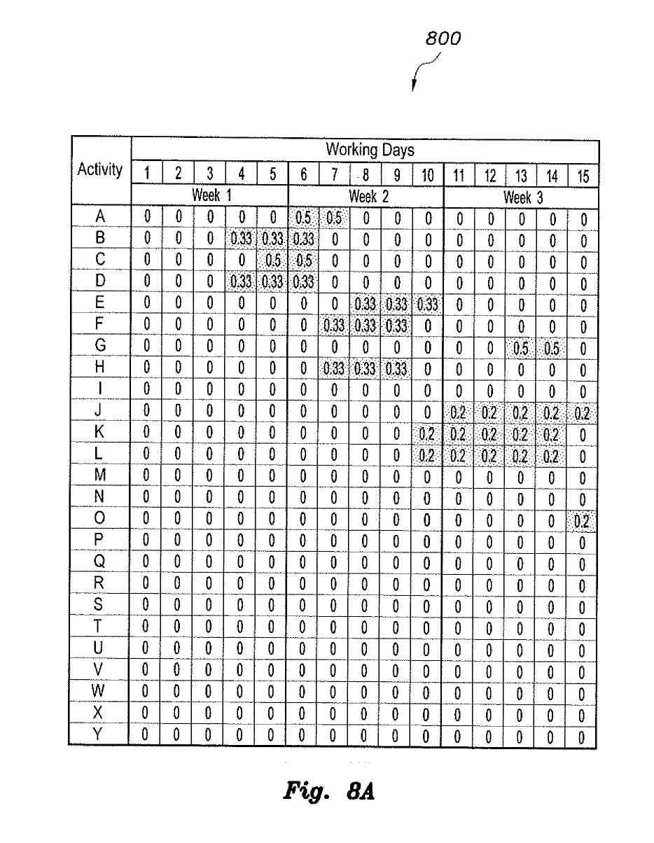

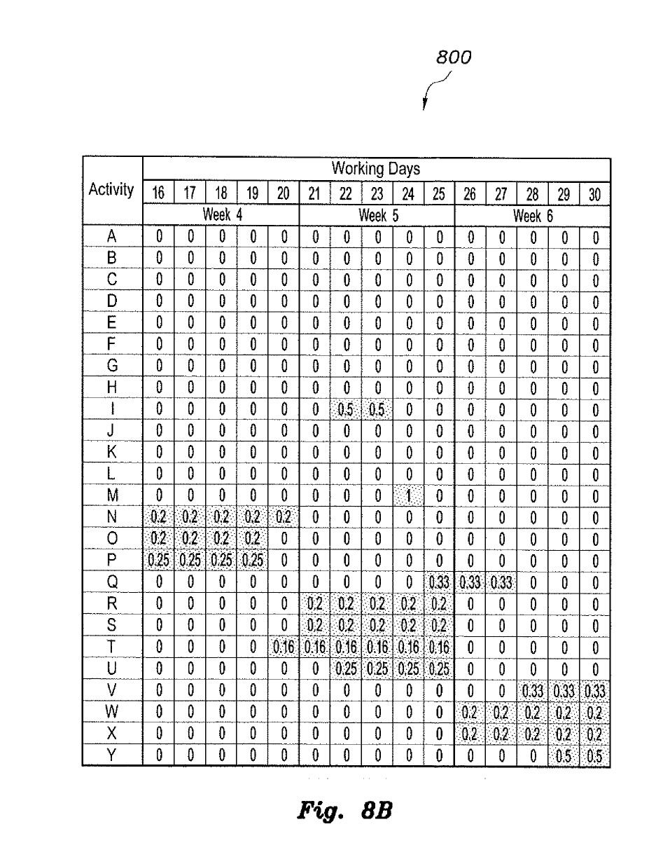

Analysis of the pattern recognition results is conducted using a reference pattern and two specially designed test patterns in order to give more insight into the pattern recognition process. The reference pattern 700, as shown in FIGS. 7A-7B, starts all activities on the late-start times and maintains the original activities' durations to finish activities on the late-start times. Thus, the progress at a given cut-off date associated with the reference pattern constitute a benchmark that indicates the minimum acceptable progress. Tables 5A-5D present the minimum planned progress values based on the individual activities for five cut-off dates, which signify the end of the first five weeks. In addition, two patterns were specially designed to address the two possible causes of progress delays, which are the delayed starts of activities and the extended duration of activities due to the slow progress. The first specially designed pattern 800, as shown in FIGS. 8A-8B and referred to as delayed-start pattern in Tables 5A-5D, starts the activities three days beyond the late-start times, maintains the original durations, and ends activities three days beyond the late-finish times.

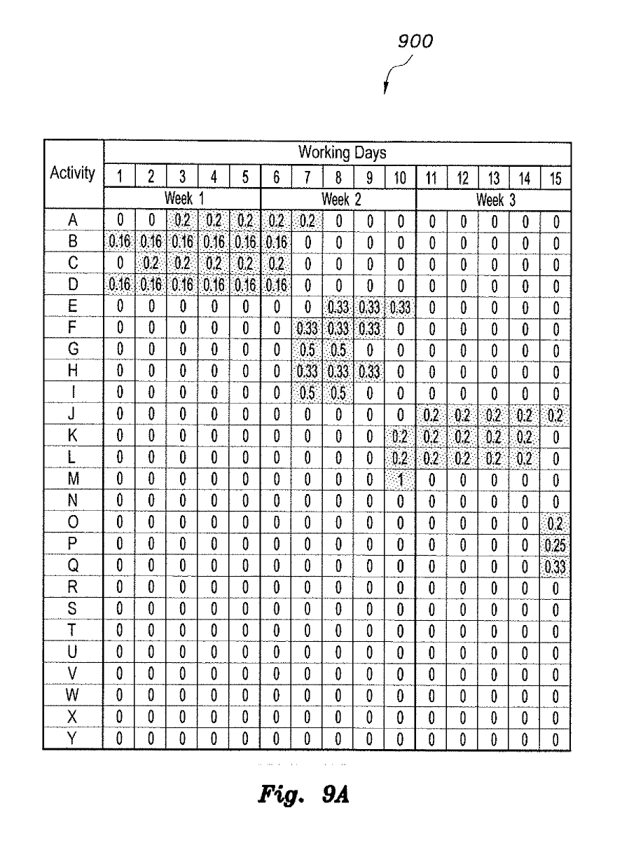

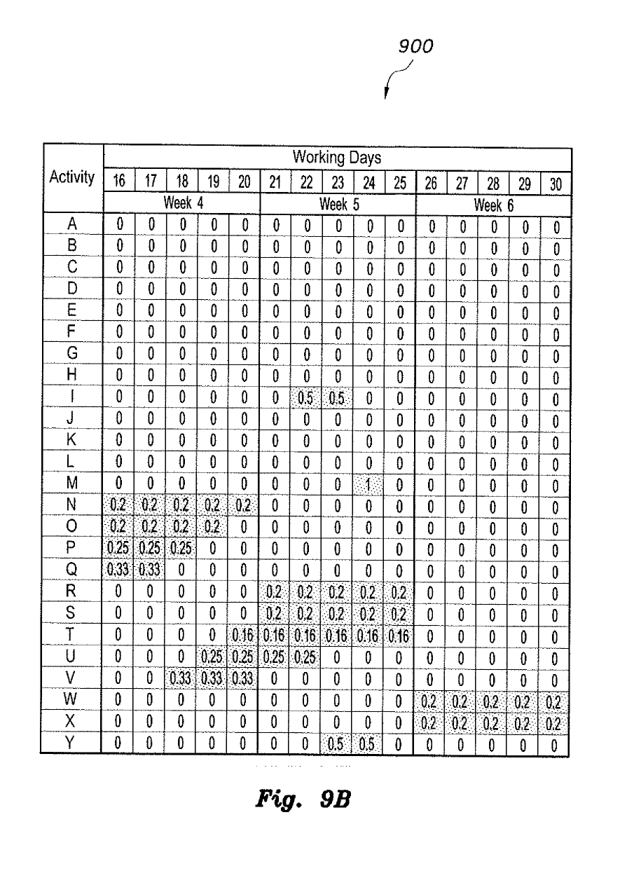

The second specially-designed pattern 900, as shown in FIGS. 9A-9B and referred to as extended-duration pattern in Tables 5A-5D, starts activities A, B, C, and D at the late-start times and relaxes the daily progress of the four activities to finish them three days beyond their late-finish times. The progress associated with the five cut-off dates based on the individual activities is presented in Tables 5A-5D. Since the two specially designed patterns have the same dimension of thirty rows by twenty-five columns, the trained NN-PR model for error-free recognitions associated with the case of monitoring with time contingency were utilized for the purpose of testing. The testing results expressed as the recognized weeks are presented in Table 5 for the NN-PR model.

TABLE 5A
Recognition sensitivity of neural network pattern recognition

| | Recognized | | | | | | | | |
|---|---|---|---|---|---|---|---|---|---|
| Weeks | week | Patterns | A | B | C | D | E | F | G |
| 1 | — | Reference | 100 | 100 | 100 | 100 | 33 | 66 | 0 |
| | 1 | Delayed | 0 | 66 | 50 | 66 | 0 | 0 | 0 |
| | | start | | | | | | | |
| | 1 | Extended | 60 | 84 | 80 | 84 | 0 | 0 | 0 |
| | | duration | | | | | | | |
| 2 | — | Reference | 100 | 100 | 100 | 100 | 100 | 100 | 50 |
| | 1 | Delayed | 100 | 100 | 100 | 100 | 100 | 100 | 0 |
| | | start | | | | | | | |
| | 2 | Extended | 100 | 100 | 100 | 100 | 99 | 99 | 100 |
| | | duration | | | | | | | |
| 3 | — | Reference | 100 | 100 | 100 | 100 | 100 | 100 | 100 |
| | 2 | Delayed | 100 | 100 | 100 | 100 | 100 | 100 | 100 |
| | | start | | | | | | | |
| | 2 | Extended | 100 | 100 | 100 | 100 | 100 | 100 | 100 |
| | | duration | | | | | | | |
| 4 | — | Reference | 100 | 100 | 100 | 100 | 100 | 100 | 100 |
| | 3 | Delayed | 100 | 100 | 100 | 100 | 100 | 100 | 100 |
| | | start | | | | | | | |
| | 4 | Extended | 100 | 100 | 100 | 100 | 100 | 100 | 100 |
| | | duration | | | | | | | |
| 5 | — | Reference | 100 | 100 | 100 | 100 | 100 | 100 | 100 |
| | 4 | Delayed | 100 | 100 | 100 | 100 | 100 | 100 | 100 |
| | | start | | | | | | | |
| | 5 | Extended | 100 | 100 | 100 | 100 | 100 | 100 | 100 |
| | | duration | | | | | | | |

Reference: activities start at late-start time and end at late-finish time.
Delayed start: Activities start three days after the late start and end 3 days after the late finish.
Extended duration: Activities A, B, C, D start at the late start time and end 3 day after the late finish with the relaxed daily rate.

TABLE 5B
Recognition sensitivity of neural network
pattern recognition (cont'd)

| | Recog- | | | | | | | |
|---|---|---|---|---|---|---|---|---|
| | nized | | | | | | | |
| Weeks | week | Patterns | H | I | J | K | L | M |
| 1 | — | Reference | 66 | 0 | 0 | 0 | 0 | 0 |
| | 1 | Delayed | 0 | 0 | 0 | 0 | 0 | 0 |
| | | start | | | | | | |
| | 1 | Extended | 0 | 0 | 0 | 0 | 0 | 0 |
| | | duration | | | | | | |
| 2 | — | Reference | 100 | 0 | 60 | 80 | 80 | 0 |
| | 1 | Delayed | 100 | 0 | 0 | 20 | 20 | 0 |
| | | start | | | | | | |
| | 2 | Extended | 99 | 100 | 0 | 20 | 20 | 100 |
| | | duration | | | | | | |
| 3 | — | Reference | 100 | 100 | 100 | 100 | 100 | 0 |
| | 2 | Delayed | 100 | 0 | 100 | 100 | 100 | 0 |
| | | start | | | | | | |
| | 2 | Extended | 100 | 100 | 100 | 100 | 100 | 100 |
| | | duration | | | | | | |
| 4 | — | Reference | 100 | 100 | 100 | 100 | 100 | 0 |
| | 3 | Delayed | 100 | 100 | 100 | 100 | 100 | 0 |
| | | start | | | | | | |
| | 4 | Extended | 100 | 100 | 100 | 100 | 100 | 100 |
| | | duration | | | | | | |
| 5 | — | Reference | 100 | 100 | 100 | 100 | 100 | 100 |
| | 4 | Delayed | 100 | 100 | 100 | 100 | 100 | 100 |
| | | start | | | | | | |
| | 5 | Extended | 100 | 100 | 100 | 100 | 100 | 100 |
| | | duration | | | | | | |

TABLE 5C
Recognition sensitivity of neural network
pattern recognition (cont'd)

| | Recog- | | | | | | | |
|---|---|---|---|---|---|---|---|---|
| | nized | | | | | | | |
| Weeks | week | Patterns | N | O | P | Q | R | S |
| 1 | — | Reference | 0 | 0 | 0 | 0 | 0 | 0 |
| | 1 | Delayed | 0 | 0 | 0 | 0 | 0 | 0 |
| | | start | | | | | | |
| | 1 | Extended | 0 | 0 | 0 | 0 | 0 | 0 |
| | | duration | | | | | | |
| 2 | — | Reference | 0 | 0 | 0 | 0 | 0 | 0 |
| | 1 | Delayed | 0 | 0 | 0 | 0 | 0 | 0 |
| | | start | | | | | | |
| | 2 | Extended | 0 | 0 | 0 | 0 | 0 | 0 |
| | | duration | | | | | | |
| 3 | — | Reference | 60 | 80 | 75 | 0 | 0 | 0 |
| | 2 | Delayed | 0 | 20 | 0 | 0 | 0 | 0 |
| | | start | | | | | | |
| | 2 | Extended | 0 | 20 | 25 | 33 | 0 | 0 |
| | | duration | | | | | | |
| 4 | — | Reference | 100 | 100 | 100 | 0 | 60 | 60 |
| | 3 | Delayed | 100 | 100 | 100 | 0 | 0 | 0 |
| | | start | | | | | | |
| | 4 | Extended | 100 | 100 | 100 | 100 | 0 | 0 |
| | | duration | | | | | | |
| 5 | — | Reference | 100 | 100 | 100 | 100 | 100 | 100 |
| | 4 | Delayed | 100 | 100 | 100 | 33 | 100 | 100 |
| | | start | | | | | | |
| | 5 | Extended | 100 | 100 | 100 | 100 | 100 | 100 |
| | | duration | | | | | | |

TABLE 5D
Recognition sensitivity of neural network
pattern recognition (cont'd)

| | Recog- | | | | | | | |
|---|---|---|---|---|---|---|---|---|
| | nized | | | | | | | |
| Weeks | week | Patterns | T | U | V | W | X | Y |
| 1 | — | Reference | 0 | 0 | 0 | 0 | 0 | 0 |
| | 1 | Delayed start | 0 | 0 | 0 | 0 | 0 | 0 |
| | 1 | Extended | 0 | 0 | 0 | 0 | 0 | 0 |
| | | duration | | | | | | |
| 2 | — | Reference | 0 | 0 | 0 | 0 | 0 | 0 |
| | 1 | Delayed start | 0 | 0 | 0 | 0 | 0 | 0 |
| | 2 | Extended | 0 | 0 | 0 | 0 | 0 | 0 |
| | | duration | | | | | | |
| 3 | — | Reference | 0 | 0 | 0 | 0 | 0 | 0 |
| | 2 | Delayed start | 0 | 0 | 0 | 0 | 0 | 0 |
| | 2 | Extended | 0 | 0 | 0 | 0 | 0 | 0 |
| | | duration | | | | | | |
| 4 | — | Reference | 67 | 50 | 0 | 0 | 0 | 0 |
| | 3 | Delayed start | 16 | 0 | 0 | 0 | 0 | 0 |
| | 4 | Extended | 17 | 50 | 99 | 0 | 0 | 0 |
| | | duration | | | | | | |
| 5 | — | Reference | 100 | 100 | 33 | 60 | 60 | 0 |
| | 4 | Delayed start | 100 | 100 | 0 | 0 | 0 | 0 |
| | 5 | Extended | 100 | 100 | 100 | 0 | 0 | 100 |
| | | duration | | | | | | |

The results in Tables 5A-5D indicate that the recognition results of the delayed-start pattern were one week behind. This happened because activities G, j, K, and L were behind when the project was monitored at end of the second week. Similarly, activities I, N, O, and P; activities R, 5, T, and U; and activities Q, V, W, and X were behind when the project was monitored at end of the third, fourth, and fifth weeks respectively. This finding clearly proves that the NN-PR model was very sensitive to the delayed-start times of the activities. On the other hand, the results in Tables 5A-5D indicate discrepancies regarding the recognition results of the extended-duration pattern at the end of the third week. This happened because some activities were ahead and some others were behind when the project was monitored at the end of the third week. While the same problem happened at the end of the second, fourth, and fifth weeks, these weeks were recognized correctly. This finding clearly proves that the NN-PR model was very sensitive to the extended-duration pattern.

The process of traditional monitoring, which compares the actual progress of individual activities against single-valued benchmarks, often results in great variation in the quality of data collected due to reporting skills, as well as willingness to record accurately. The main objective of this research was to utilize the NN-PR technique to classify the planned progress at the specified cut-off dates during the planning stage and use this classification to monitor and evaluate the actual progress during the construction stage. The PR models were investigated regarding the issues of time contingency, and recognition sensitivity. Finally, the PR concept and technique proved its robustness to monitor and evaluate progress of construction projects based on the CPM technique.

The generalization feature that the pattern recognition models bring about offers a potential concept and technique to overcome the problem of variation in the quality of data collected. The PR technique generalizes a virtual benchmark to represent the planned progress based on multiple possible outcomes generated at each cut-off date. The merits that the generalized benchmark offers include: the effect of the imprecision in data collection, which happens due to either the lack of experience or the nature of the work, which makes it difficult to figure out the accurate actual progress on the evaluation of the status of activities and the whole project, is significantly diminished; the impetus for personnel to inaccurately report data on-purpose is entirely negated as the actual progress is being evaluated against a virtual benchmark; and a fair overall evaluation of the project, considering both slow-progressed and well-progressed activities, is presented to the field personnel while keeping the single-valued benchmarks of the individual activities exclusively to project managers to analyze situations and make decisions.

In use, a Critical Path Method (CPM) schedule of a project is first built. Then, during a planning stage of the project, pattern sets of cut-off dates of the project to the CPM schedule are mapped. During the planning stage, project cut-off date weeks corresponding to the pattern sets of the project cut-off dates are identified, and the pattern sets and corresponding project cut-off date weeks are applied as inputs to a neural network pattern recognition model, which is preferably a neural network pattern recognition model of a Hopfield network.

At least one of the generated patterns is then used to train the neural network pattern recognition model to classify work planned at specified cut-off dates. The remaining patterns are used to test the neural network pattern recognition model after it has been trained. During the construction stage of the project, at the same cut-off dates, the project is monitored.

At any desired cut-off date, a corresponding descriptive pattern is prepared, such that the corresponding descriptive pattern describes actual work accomplishments during a time period defined by the desired cut-off date. The descriptive pattern is input into the neural network pattern recognition model, with the model declaring a week of convergence for the descriptive pattern input. The week of convergence declared by the neural network pattern recognition model is compared to the cut-off date week of the associated cut-off date pattern set, thereby determining whether actual progress of the project is on schedule, ahead of schedule, or behind schedule. A progress monitoring report is then prepared based upon the determined actual progress, and the progress monitoring report is displayed to a user.

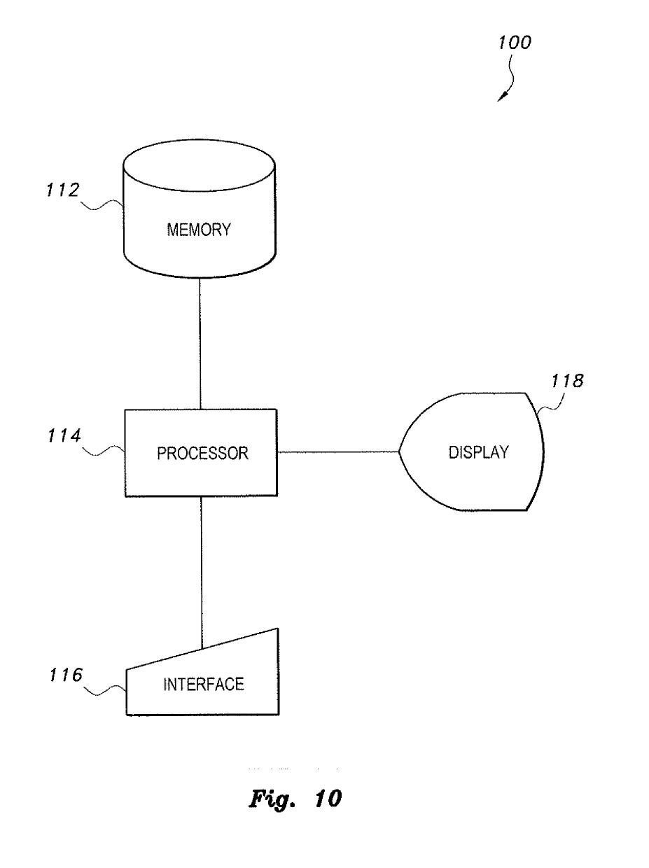

It should be understood that the calculations may be performed by any suitable computer system, such as that diagrammatically shown in FIG. 10. Data is entered into system 100 via any suitable type of user interface 116, and may be stored in memory 112, which may be any suitable type of non-transitory computer readable and programmable memory. Calculations are performed by processor 114, which may be any suitable type of computer processor and may be displayed to the user on display 118, which may be any suitable type of computer display.

Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of non-transitory computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiment described above, but encompasses any and all embodiments within the scope of the following claims.

We claim:

1. A computer software product that includes a storage medium readable by a processor, the storage medium having stored thereon a set of instructions for performing monitoring of progress schedules, the instructions comprising:
(a) a first set of instructions which, when loaded into main memory and executed by the processor, causes the processor to build a Critical Path Method (CPM) schedule of a project;
(b) a second set of instructions which, when loaded into main memory and executed by the processor, causes the processor to map, during a planning stage of the project, pattern sets of cut-off dates of the project to the CPM schedule;
(c) a third set of instructions which, when loaded into main memory and executed by the processor, causes the processor to identify, during the planning stage, project cut-off date weeks corresponding to the pattern sets of the project cut-off dates;
(d) a fourth set of instructions which, when loaded into main memory and executed by the processor, causes the processor to apply the pattern sets and corresponding project cut-off date weeks as inputs to a neural network pattern recognition model of a Hopfield network;
(e) a fifth set of instructions which, when loaded into main memory and executed by the processor, causes the processor to use at least one of the generated patterns to train the neural network pattern recognition model to classify work planned at specified cut-off dates;
(f) a sixth set of instructions which, when loaded into main memory and executed by the processor, causes the processor to use the remaining patterns to test the neural network pattern recognition model after it has been trained;
(g) a seventh set of instructions which, when loaded into main memory and executed by the processor, causes the processor to monitor the project, during the construction stage of the project, at the same cut-off dates;
(h) an eighth set of instructions which, when loaded into main memory and executed by the processor, causes the processor to prepare, at any desired cut-off date, a corresponding descriptive pattern, the corresponding descriptive pattern describing actual work accomplishments during a time period defined by the desired cut-off date;
(i) a ninth set of instructions which, when loaded into main memory and executed by the processor, causes the processor to input the descriptive pattern to the neural network pattern recognition model, the model declaring a week of convergence for the descriptive pattern input;
(j) a tenth set of instructions which, when loaded into main memory and executed by the processor, causes the processor to compare the week of convergence declared by the neural network pattern recognition model to the cut-off date week of the associated cut-off date pattern set, thereby determining whether actual progress of the project is on schedule, ahead of schedule, or behind schedule;
(k) an eleventh set of instructions which, when loaded into main memory and executed by the processor, causes the processor to generate a progress monitoring report based upon the determined actual progress; and
(l) a twelfth set of instructions which, when loaded into main memory and executed by the processor, causes the processor to display the progress monitoring report to a user.

2. The computer software product according to claim 1, wherein the fifth set of instructions further comprises using a high-speed neural network pattern recognition model training algorithm.

3. The computer software product according to claim 1, wherein the fourth set of instructions further comprises using a neural network pattern recognition model having a single hidden layer.

4. The computer software product according to claim 3, wherein the fourth set of instructions further comprises using approximately forty-three neurons in said single hidden layer.

5. The computer software product according to claim 1, further comprising a thirteenth set of instructions which, when loaded into main memory and executed by the processor, causes the processor to benchmark the entire project based on multiple possible outcomes generated by said neural network pattern recognition model at each said cut-off date.

6. The computer software product according to claim 1, further comprising a fourteenth set of instructions which, when loaded into main memory and executed by the processor, causes the processor to associate an output pattern including a vector having a number of elements equal to the total number of project weeks with each input pattern.

7. The computer software product according to claim 1, further comprising a fifteenth set of instructions which, when loaded into main memory and executed by the processor, causes the processor to construct additional patterns at each cut-off date, the additional patterns being generated by randomly assigning values to the activities' start times within a range of an early start time (EST) and a late start time (LST), while maintaining a sequence of the activities, the additional patterns representing multiple possible patterns leading to the same project duration;
wherein sets of random patterns at all the specified cut-off dates along with their corresponding weeks constitute inputs to feed to the neural network pattern recognition model.

8. The computer software product according to claim 1, wherein the fifth set of instructions further comprises constructing a plurality of training pattern groups, each training pattern group of the plurality of training pattern groups being uniquely associated with each interval of the longest time period shown in the CPM schedule, the training pattern groups being split further into a first number of sub-groups and a second number of sub-groups, individual patterns of the first number of sub-groups being used for updating the neural network weights and biases while being entered randomly to the neural network, the second number of sub-groups being used for validation.

9. The computer software product according to claim 8, further comprising a sixteenth set of instructions which, when loaded into main memory and executed by the processor, causes the processor to validate the neural network pattern recognition model, the validation including a stopping criterion such that when a pattern recognition error first begins to increase, the training session is stopped, and weights and biases of the neural network pattern recognition model corresponding to a minimum pattern recognition error value are returned.

10. The computer software product according to claim 8, further comprising a seventeenth set of instructions which, when loaded into main memory and executed by the processor, causes the processor to validate the neural network pattern recognition model, the validation including a stopping criterion, wherein training continues until a maximum number of 50 epochs occurs.

11. The computer software product according to claim 9, wherein the minimum pattern recognition error is less than about 1×10⁻⁸.

12. A computerized progress monitoring method carried out on a computer programmed to implement a Hopfield neural network, comprising the steps of:
building a Critical Path Method (CPM) schedule of a project;
mapping, during a planning stage of the project, pattern sets of cut-off dates of the project to the CPM schedule;
identifying, during the planning stage, project cut-off date weeks corresponding to the pattern sets of the project cut-off dates;
applying the pattern sets and corresponding project cut-off date weeks as inputs to a neural network pattern recognition model on the computer;
using at least one of the generated patterns to train the neural network pattern recognition model on the computer to classify work planned at specified cut-off dates;
using the remaining patterns to test the neural network pattern recognition model on the computer after it has been trained;
monitoring the project, during the construction stage of the project, at the same cut-off dates;
preparing, at any desired cut-off date, a corresponding descriptive pattern, the corresponding descriptive pattern describing actual work accomplishments during a time period defined by the desired cut-off date;
inputting the descriptive pattern to the neural network pattern recognition model on the computer, the model declaring a week of convergence for the descriptive pattern input; and
comparing the week of convergence declared by the neural network pattern recognition model to the cut-off date week of the associated cut-off date pattern set thereby, indicating whether actual progress of the project is on schedule, ahead of schedule, or behind schedule.

13. The progress monitoring method according to claim 12, wherein the neural network pattern recognition model has a single hidden layer.

14. The progress monitoring method according to claim 13, further comprising the step of using approximately forty-three neurons in said single hidden layer.

15. The progress monitoring method according to claim 12, further comprising the step of benchmarking the entire project based on multiple possible outcomes generated by said neural network pattern recognition model on the computer at each said cut-off date.

16. The progress monitoring method according to claim 12, further comprising the step of associating an output pattern including a vector having a number of elements equal to the total number of project weeks with each input pattern.

17. The progress monitoring method according to claim 12, further comprising the step of constructing additional patterns at each cut-off date, the additional patterns being generated on the computer by randomly assigning values to the activities' start times within a range of an early start time (EST) and a late start time (LST), while maintaining a sequence of the activities, the additional patterns representing multiple possible patterns leading to the same project duration;
wherein sets of random patterns at all the specified cut-off dates along with their corresponding weeks constitute inputs to feed to the neural network pattern recognition model.

18. The progress monitoring method according to claim 12, wherein the training step further comprises the step of constructing a plurality of training pattern groups, each training pattern group of the plurality of training pattern groups being uniquely associated with each interval of the longest time period shown in the CPM schedule, the training pattern groups being split further into a first number of sub-groups and a second number of sub-groups, individual patterns of the first number of sub-groups being used for updating the neural network weights and biases while being entered randomly to the neural network on the computer, the second number of sub-groups being used for a validating step.

19. The progress monitoring method according to claim 18, further comprising the step of validating the neural network pattern recognition model on the computer, the validating step including a stopping criterion such that when a pattern recognition error first begins to increase, the training session is stopped, and weights and biases of the neural network pattern recognition model corresponding to a minimum pattern recognition error value are returned.

20. The progress monitoring method according to claim 18, further comprising the step of validating the neural network pattern recognition model using the computer, the validating step including a stopping criterion wherein training continues until a maximum number of 50 epochs occurs.
